(19) United States
(12) Patent Application Publication
(10) Pub. No.: US 2004/0153013 A1
(43) Pub. Date: Aug. 5, 2004

(54) Pelvic support system

(76) Inventor: Matthew N. Osborne, Columbus, OH (US)

Correspondence Address: Frederick B. Ziesenheim, WEBB ZIESENHEIM LOGSDON ORKIN & HANSON, P.C., 700 Koppers Building, 436 Seventh Avenue, Pittsburgh, PA, 15219-1818, US

(21) Appl. No.: 10/727,080

(22) Filed: Dec. 3, 2003

Related U.S. Application Data
(60) Provisional application No. 60/430,586, filed on Dec. 3, 2002.

(51) Int. Cl. A61H 23/00

(52) U.S. Cl. 601/46; 601/56; 601/59

(57) ABSTRACT

A pelvic support system includes a source of vibration, such as an engine of a motorcycle, connected to a frame. A first seat, such as a seat of a motorcycle, is connected to the frame. A secondary pelvic support is removably positioned adjacent to the first seat. When the source of vibration is started, vibrations from the engine propagate from the engine to the first seat and to the secondary pelvic support. The gentle vibration of the secondary pelvic support in an area of a rider's pelvic region stimulates the pelvic region, thus making the motorcycle ride more pleasurable. A method utilizing the pelvic support system is also disclosed.

### CROSS-REFERENCE TO RELATED APPLICATIONS

This application claims the benefit of U.S. Provisional Patent Application Serial No. 60/430,586, filed Dec. 3, 2002.

### BACKGROUND OF THE INVENTION

1. Field of the Invention

The present invention generally relates to a pelvic support and, more particularly, to a secondary pelvic support which transmits vibration frequencies originating from an external source to a pelvic area of a person.

2. Description of Related Art

U.S. Pat. No. 6,436,029 to Benderev and U.S. Pat. No. 5,762,589 to Parker, Jr., both herein incorporated by reference in their entireties, disclose exercise apparatuses for the pelvic area.

The Benderev patent generally includes an elongated saddle that defines a cushioning member and includes a signaling device. In operation, a person sits on the cushioning member, and the signaling device provides vibratory stimulation to the pelvic area.

The Parker, Jr. patent generally includes a bulbocavernosus muscle exerciser for males.

Neither of these patents disclose a pelvic support designed to be positioned adjacent to a permanent seat or using an external source of vibration to vibrate the pelvic support. Moreover, a need exists for a simple, removable, washable, and lightweight pelvic support which can provide soothing stimulation to a pelvic region of a person without relying on an internally-housed source of vibration.

### SUMMARY OF THE INVENTION

To help solve this need, the present invention generally includes a pelvic support system having a source of vibration connected to a frame, a first seat connected to the frame, and a secondary pelvic support removably positioned adjacent to the first seat.

The secondary pelvic support is preferably a raised, contoured mass molded to fit under the pelvis of a female rider oriented in a seated, straddling position with respect to the first or permanent seat and the secondary pelvic support. Attachment straps are permanently connected to the secondary pelvic support at one end and are removably connected to one another, the frame, or first seat at a second end, so that the attachment straps can be wrapped around the first seat or the frame, removably holding the secondary pelvic support in place.

The secondary pelvic support is preferably made from a material selected from plastic, malleable rubber, hard rubber, or any other suitable material. The secondary pelvic support may also be covered by a removable pouch, wherein the pouch is made from a washable material such as cloth, fabric, plastic, or other suitable material.

In one method of operation, the removable secondary pelvic support is attached to the first seat, such as by the attachment straps. When the source of vibration, such as a combustion engine, is started, vibrations from the engine propagate from the engine to the permanent seat and to the secondary pelvic support. The gentle vibration of the secondary pelvic support in the area of a rider's pelvic region stimulates the pelvic region, thus making the motorcycle ride more pleasurable.

### BRIEF DESCRIPTION OF THE DRAWINGS

FIG. 1 is a cross-sectional side view of a secondary pelvic support according to the present invention;

FIG. 2 is a top view of the secondary pelvic support shown in FIG. 1;

FIG. 3 is a top perspective view of the secondary pelvic support shown in FIGS. 1 and 2 attached to a passenger area of a first or factory seat;

FIG. 4 is a top view of a T-shaped connector and several buckle tabbed attachment straps;

FIG. 5 is a side view of a motorcycle having a first seat attached thereto, with the secondary pelvic support shown in FIGS. 1-3 removably attached to a motorcycle seat; and

FIG. 6 is a side view of the secondary pelvic support shown in FIGS. 1-3 and 5, with a human rider straddling the first seat and the secondary pelvic support.

### DETAILED DESCRIPTION OF THE INVENTION

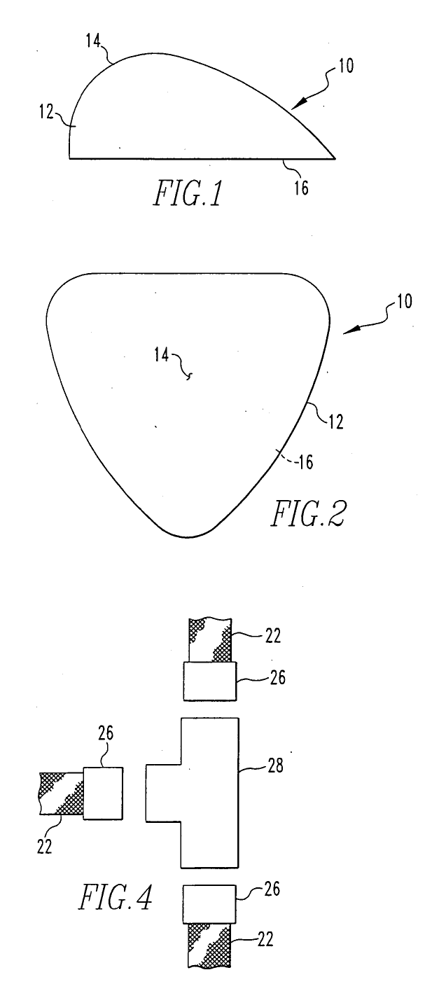

As shown in FIGS. 1 and 2, the secondary pelvic support 10 of the present invention generally includes a raised, contoured mass 12. The contoured mass 12 generally defines a curved surface 14 on one side to fit comfortably against the lower pelvic/crotch area of a person and generally defines a planar surface 16 opposite the curved surface 14. The contoured mass is generally made from plastic, rubber, or other suitable material.

As shown in FIG. 3, the planar surface 16 of the secondary pelvic support 10 is removably positioned against a seating surface 18 of a first seat (factory or permanent seat) 20 of a conveyance or may be incorporated into the seating surface 18 of the first seat 20. However, in the preferred embodiment, the secondary pelvic support 10 is removably attached to the first seat 20 by attachment straps 22 made from nylon or other suitable material. The attachment straps 22 are preferably adjustable, and adjustably wrap around the first seat 20 or frame 24 of a conveyance to releasably secure the secondary pelvic support 10 to the first seat 20. The attachment straps 22 can be bound to one another either directly or via a belt tab 26 and belt buckle 28 arrangement shown in FIG. 4. The attachment straps 18 extend around the first seat 20, frame 24, or any other suitable structure as generally shown in FIG. 3, and preferably connect to one another underneath the first seat 20.

With continuing reference to FIG. 3, the secondary pelvic support 10 according the present invention is removable and may be adjusted along an imaginary longitudinal X axis passing through the first seat 20 and an imaginary Y axis perpendicularly intersecting the imaginary longitudinal X axis. In addition, removal allows the secondary pelvic support 10 to be easily replaced or cleaned. To further aid in cleaning, the secondary pelvic support 10 can be covered in a removable outer shell (not shown) made from a machine washable material, such as nylon, cotton, plastic, or other suitable material.

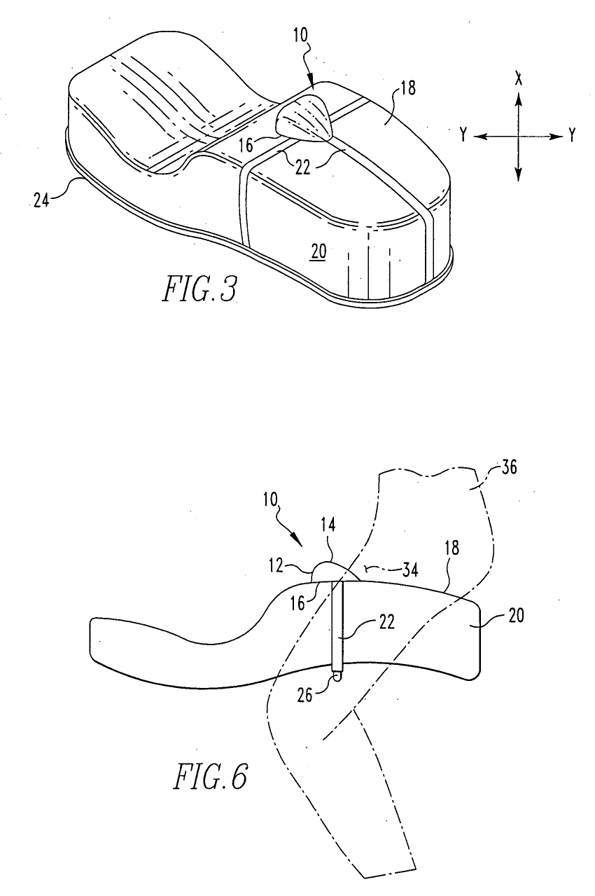

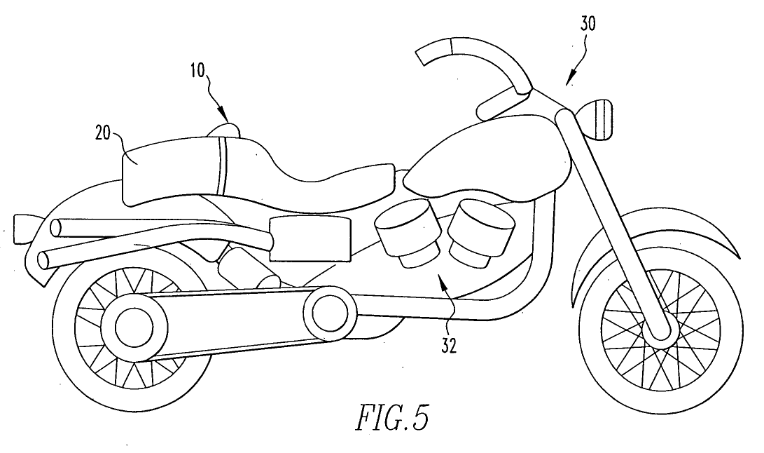

In one method of operation, as shown generally in FIG. 5, the secondary pelvic support 10 is adjustably positioned on the first seat 20 of an engine driven conveyance, such as a tractor, riding lawn mower, moped, motorcycle 30, or other suitable device. When an engine 32 of the conveyance is started, vibrations originating in the engine 32 propagate through the first seat 20 and the secondary pelvic support 10. Vibrations can increase as engine revolutions per minute (rpm) increase or as the motorcycle 30 navigates uneven or rough road surfaces. As shown in FIG. 6, a portion of vibrations propagate through the secondary pelvic support 10 to a lower pelvic/crotch area 34 of a rider 36, thus stimulating the pelvic/crotch area 34. The rider 36 can increase the focus of the propagated vibrations by shifting more of their weight onto the secondary pelvic support 10 or by realigning the secondary pelvic support 10 with respect to their crotch 34. Moreover, vibrations felt by the rider 36 may also be increased by a decrease in the amount of clothing layers positioned between the secondary pelvic support 10, by increasing the amount of surface area of the secondary pelvic support 10 physically contacting the lower pelvic region, increasing engine speed, or traveling over uneven surfaces.

The overall effect of the present invention is to make the ride more enjoyable for a rider, reduce time awareness, and focus vibrations to massage areas of the body which are normally compressed while straddling a conventional permanent motorcycle seat. Another advantage is that vibrations are produced by an outside source, such as the engine or suspension of a motorized conveyance, without the need for an additional electrical vibration motor connected to the secondary pelvic support. Moreover, the secondary pelvic support is also easily washable in a conventional washing machine, as required.

It will be understood by those skilled in the art that while the foregoing description sets forth in detail preferred embodiments of the present invention, modifications, additions, and changes might be made thereto without departing from the spirit and scope of the invention.

The invention claimed is:

1. A pelvic support system comprising:
a source of vibration connected to a frame;
a first seat connected to the frame; and
a secondary pelvic support removably positioned adjacent to the first seat.

2. The pelvic support system as claimed in claim 1, wherein the source of vibration is a combustion engine.

3. The pelvic support system as claimed in claim 1, wherein the frame is a motorcycle frame.

4. The pelvic support system as claimed in claim 1, wherein the first seat is a motorcycle seat.

5. The pelvic support system as claimed in claim 1, wherein the secondary pelvic support is a raised, contoured body shaped to abut the pelvic area of a person oriented in a seated, straddling position with respect to the first seat and the secondary pelvic support.

6. The pelvic support system as claimed in claim 1, wherein the secondary pelvic support further comprises an adjustable strap removably connected thereto.

7. The pelvic support system as claimed in claim 1, wherein the secondary pelvic support is made from a material selected from the group consisting of plastic and rubber.

8. The pelvic support system as claimed in claim 1, wherein vibrations produced by the source of vibration propagate through the first seat and the secondary pelvic support.

9. A method to make a ride on a powered conveyance more enjoyable comprising the steps of:
positioning a removable secondary pelvic support adjacent to a first seat of the powered conveyance;
starting an engine of the powered conveyance;
allowing vibration from the engine to propagate through the first seat and the secondary pelvic support; and
straddling the first seat and the secondary pelvic support so that the secondary pelvic support is positioned adjacent to a pelvic area of a rider.
